(19) United States
(12) Patent Application Publication
(10) Pub. No.: US 2005/0037245 A1
(43) Pub. Date: Feb. 17, 2005

(54) Method for hydrogen and electricity production using steam-iron process and solid oxide fuel cells

(75) Inventor: Ai Quoc Pham, San Jose, CA (US)

Correspondence Address: Edward C. Kwok;MacPHERSON KWOK CHEN & HEID LLP, Suite 226, 1762 Technology Drive, San Jose, CA, 95110, US

(73) Assignee: Evogy, Inc.

(21) Appl. No.: 10/917,269

(22) Filed: Aug. 11, 2004

Related U.S. Application Data
(60) Provisional application No. 60/494,418, filed on Aug. 11, 2003.

(51) Int. Cl. H01M 8/06; C01B 3/26

(52) U.S. Cl. 429/17; 423/651

(57) ABSTRACT

A method and a system for the co-production of electricity and hydrogen fuel are provided. The system may include a fuel conditioning unit, two or more iron/iron oxide beds and a high temperature electrochemical generator. In one embodiment, a reduction bed contains iron oxides. A hydrocarbon fuel, such as natural gas, is conditioned to carbon dioxide and hydrogen by the reduction bed. The conditioned fuel is then converted electrochemically to generate electricity in a fuel cell. Operating simultaneously is an oxidation bed that oxidizes elemental iron to iron oxides and produces hydrogen. The oxidation bed may previously have served as the reduction bed. The hydrogen thus produced is sufficiently pure to be used in a refueling application. The heat necessary for the endothermic reduction may be provided by the high temperature electrochemical generator. The two beds may operate concurrently or sequentially, and alternate their roles when their reactants are partially exhausted.

### CROSS REFERENCE TO RELATED APPLICATIONS

The present application is related to and claims priority to U.S. provisional patent application “Hydrogen and Electricity Production using Steam-Iron Process and Solid Oxide Fuel Cells,” Ser. No. 60/494,418, filed on Aug. 11, 2003.

### BACKGROUND OF THE INVENTION

1. Field of the Invention

The present invention relates to the energy conversion processes and fuel processing in fuel cells. In particular the present invention relates to systems and processes for on-site production of hydrogen and other fuels to operate fuel cells.

2. Discussion of the Related Art

Concerns about greenhouse gas effects have generated great interest in developing energy technologies with low emissions. Fuel cells, owing to their much higher efficiencies, have the potential to reduce greenhouse gas emissions by one half or more. For this reason, fuel cells are believed suitable for stationary power generation and transportation applications.

One of the hurdles that have hampered extensive use of fuel cells is the absence of a hydrogen fuel infrastructure. Indeed, hydrogen is by far the preferred fuel for most fuel cells, and particularly for the Polymer Electrolyte Membrane Fuel Cells (PEMFCs), the leading candidate for transportation application. Unfortunately, free hydrogen is not available directly. At present, hydrogen can only be produced from such sources as fossil fuels, biomass or water. Existing hydrogen production technologies using fossil fuels or water are believed impractical for widespread use. For example, producing hydrogen using water electrolysis is expensive because of the high cost of the electricity necessary for the process. Inexpensive large scale production of hydrogen at large plants is possible. However, delivery to where the hydrogen is consumed is costly and complex because of the low energy density of gaseous hydrogen.

To avoid the issues of transporting hydrogen, hydrogen should be produced on-site, i.e. close the locations where it will be used or dispensed. Ideally, hydrogen should be produced at the refueling station, where it would be stored in high-pressure tanks and dispensed to the cars as required. Unfortunately, conventional technologies for producing hydrogen at large central plants can not be economically scaled down without heavy capital investment and efficiency loss.

A number of technologies (e.g., small-scale steam reforming, partial oxidation and autothermal reforming) are currently being developed for small-scale hydrogen production. Steam reforming involves reacting hydrocarbon fuels with steam to create carbon monoxide and hydrogen. For example, with methane fuel, the steam reforming reaction is described by:
CH₄+H₂O→CO+3H₂ ΔH=206 kJ/mol CH₄ [1]

As indicated, the steam reformation reaction described by reaction [1] using methane is highly endothermic. Typically, 25% of the fuel is consumed to provide the heat to drive the reaction forward. A large excess of steam, as much as two to three time more steam than carbon, is required to prevent carbon deposits. Reactors for this reaction, which are typically designed to heat transfer considerations, are large and heavy.

Partial oxidation uses a sub-stoichiometric amount of air or oxygen to carry out an incomplete combustion of the fuel. The heat from the combustion drives the reaction. Since no indirect heat transfer is needed, the partial oxidation reactor is more compact and better suited for small-scale hydrogen production. One problem associated with partial oxidation is fuel dilution by nitrogen, if air is used as oxidant.

Autothermal reforming combines steam reforming and partial oxidation. Autothermal reforming thus suffers also from fuel dilution by nitrogen, if air is used as oxidant.

In each of the steam reformation, partial oxidation and autothermal reforming reactions discussed above, the carbon monoxide formed is allowed to subsequently react with water to produce more hydrogen:
CO+H₂O→CO₂+H₂ ΔH=−41 kJ/mol [2]

As indicated, this reaction is exothermic. Typically, the reaction described by reaction [2] is performed in two reactors operating at high and low temperatures. The resulting hydrogen rich mixture may be used in some fuel cells (e.g., the Phosphoric Acid Fuel Cells), but may contain too high a concentration of carbon monoxide to be used in PEMFCs. Conventionally, the carbon monoxide is removed using a preferential oxidation or methanation reactor. Hydrogen can also be separated out from the rest of the mixture using a gas separation technique (e.g., a hydrogen permeable membrane or pressure swing adsorption). The hydrogen separated may be stored in a high-pressure tank or be used to form metal hydrides. A hydrogen storage unit is necessary for a refueling station application. Hydrogen stored in a high pressure tank at a refueling station can be dispensed to individual fuel cell vehicles, which will store the hydrogen in on-vehicle high pressure tanks.

Therefore, in each of the steam reformation, partial oxidation and autothermal reforming reactions discussed above, because the carbon monoxide is required to be separated from the hydrogen stream, four reactors are required in the system. Beside cost, integrating the four reactors is an engineering challenge, especially at a small scale.

Hydrogen can also be produced from coal using the so-called “steam-iron” process (see, for instance, M. Steinberg and H. C. Cheng, in International Journal of Hydrogen Energy 14 (11) (1989) 797). The steam-iron process begins with a gasification reaction of coal in steam and air or oxygen. The gasification reaction produces syngas, which is a mixture of hydrogen and carbon monoxide, with steam and air or oxygen. The syngas is then flowed over an iron oxide bed to reduce the iron oxide to elemental iron. The elemental iron is then reacted with steam to produce hydrogen and iron oxide, thus completing the process. The steam-iron process generates pure hydrogen that is not contaminated by carbon monoxide or carbon dioxide. However, coal gasification cannot be readily carried out in a small scale.

Fuel cells, which are based on an electrochemical process, rather than direct combustion, are not limited by the Carnot cycle, and thus achieve a much higher efficiency than conventional power generation techniques. Currently, fuel cells use fossil fuels because a cheap source of hydrogen is not available. Most fuel cells, however, cannot operate directly on a hydrocarbon fuel because of the low reactivity of hydrocarbon. Also, harmful carbon may deposit on the fuel cell electrodes. To date, most fuel cells require a fuel processing step to convert the hydrocarbon fuel into a more reactive mixture containing carbon monoxide and hydrogen. This mixture is then used in high temperature fuel cells, such as Solid Oxide Fuel Cells (SOFCs) and Molten Carbonate Fuel Cells (MCFCs). To be used in PEMFCs, this mixture is further purified to remove carbon monoxide.

Any fuel processing step would necessarily cause a drop in overall system efficiency. For instance, a typical fuel processor has an efficiency of 80% or lower. When such a fuel processor is used in a PEMFC system having a 50% efficiency, the system efficiency drops to below 40%. Moreover, the fuel processor adds a significant cost and complexity to the fuel cell system. In fact, the fuel processor cost may even be higher than the fuel cell stack cost, and the fuel processor size can even be larger than the fuel cell stack itself, especially in PEMFC systems.

Another disadvantage of most fuel processing steps is fuel dilution by either nitrogen from air, as in the case of partial oxidation and autothermal reforming processes, or steam and carbon dioxide, as in steam and autothermal reforming processes. Fuel dilution may cause a significant drop in fuel cell performance. For instance, the article “Development of Reduced Temperature Solid Oxide Fuel Cell Power Systems” by N, Minh et al, Proceedings of the Sixth International Symposium on Solid Oxide Fuel Cells, p. 68, 1999, discloses a partial oxidation processor that generates reformate gas containing 19% hydrogen, 24% carbon monoxide, 1% carbon dioxide and as much as 56% nitrogen on a dry gas basis. In the presence of steam, the fuel dilution is even more severe. Using the partial oxidation processor described above, Minh et al reported a fuel cell performance of less than 60% relative to the corresponding fuel cell performance when a pure hydrogen fuel is used.

Therefore, a better technique to condition a hydrocarbon fuel for use in a fuel cell is desired. Such a technique should preferably avoid fuel dilution, and be simple and low cost. Further, a better hydrogen production technique that is suitable for small scale production is desired. The hydrogen production technique should be simpler (e.g., involving less steps in gas purification) and suffering less fuel dilution by unwanted gases such as nitrogen than processes in the prior art.

### SUMMARY

The present invention relates to a method and a system for generating both hydrogen and electricity. A method of the present invention combines a steam-iron process for producing hydrogen from a hydrocarbon fuel with the electrochemical operation of a high temperature fuel cell (e.g., a solid oxide fuel cell (SOFC)).

According one embodiment of the present invention, a hydrocarbon fuel in contact with a bed of iron oxides is converted into syngas, which is a mixture of carbon monoxide and hydrogen, while the iron oxides are reduced to elemental iron. The syngas then serves as a fuel for a SOFC, which converts the syngas electrochemically into carbon dioxide and steam, while generating electricity and heat. Hydrogen is produced when the steam from the fuel cell operation is provided over an iron bed to regenerate the iron oxides from the elemental iron. The present invention thus provides a method and an apparatus for continuously supplying conditioned fuel from a hydrocarbon to an electrochemical generator (e.g., a SOFC), while also supplying hydrogen which may be used in a refueling application.

According to one embodiment of the present invention, an iron bed and an iron oxide bed are provided for fuel reforming or conditioning. The iron oxide bed (containing iron oxides at high oxidation states) operates in a reduction mode to form elemental iron or iron oxides with low oxidation states, while conditioning the hydrocarbon fuel for the SOFC. The iron bed (containing elemental iron and iron oxides at low oxidation states) operates in an oxidation mode to form in a steam atmosphere iron oxides with high oxidation states. The iron bed and the iron oxide bed may be operated either sequentially or concurrently (i.e., the two beds operate simultaneously, each bed operating alternately in reduction and oxidation modes). Control mechanisms, such as valves, may be provided to control the incoming gases to the beds.

By oxidizing elemental iron metal in steam, a method of the present invention produces hydrogen with very low carbon monoxide contamination, with little or no dilution by undesirable gases. According to one embodiment, the hydrogen at high pressure is produced by pressurizing steam in the iron bed during the oxidation phase.

According to one embodiment of the present invention, syngas generated during the regeneration of elemental iron is supplied to a SOFC to generate electricity electrochemically.

A method of the present invention generates hydrogen and electricity with great flexibility. During high electricity demand, the hydrogen produced from the iron oxidation bed may be used to further generate electricity in either the high temperature electrochemical generator, or in a separate low temperature fuel cell (e.g., a proton exchange membrane fuel cell).

In summary, the present invention provides a higher efficiency over the prior art because it integrates hydrogen production with fuel cell operation. As the steam requirement in a method according to the present invention is lower, fuel dilution by nitrogen, for example, is avoided. The present invention allows dynamic adjustment to the relative amounts of hydrogen and electricity output. In addition, the present invention imposes a lesser hydrogen purification or separation requirement because the hydrogen produced is almost pure. The combined production of fuel cell and fuel processing potentially reduces capital cost relative to a system having independent fuel cell and fuel processor.

The present invention is better understood upon consideration of the detailed description below and the accompanying drawings.

### BRIEF DESCRIPTION OF THE DRAWINGS

FIG. 1 shows schematically a bed of iron oxide (101b) being reduced and a bed of iron (101a) being oxidized to provide a continuous supply of conditioned fuel 104 to fuel cell 102 and a supply of hydrogen 109 for storage, in accordance with one embodiment of the present invention.

FIG. 2 shows schematically hydrogen stream 109a produced from oxidation bed 101a is mixed with conditioned hydrocarbon fuel 104 from reduction bed 101a and directed to the high temperature electrochemical generator (i.e., fuel cell 102) for electricity generation, in accordance with one embodiment of the present invention.

FIG. 3 illustrates schematically hydrogen stream 109 produced from oxidation bed 101a is purified and provided to proton exchange membrane fuel cell (PEMFC) 113 for further electricity generation.

FIG. 4 illustrates schematically hydrocarbon fuel pre-reformed in reformer 115; a portion of the reformed fuel 116a is directed to reduction bed 101b, while the remaining (i.e., reformed fuel flow 116b) is directed to a high temperature electrochemical generator (e.g., SOFC 102), in accordance with one embodiment of the present invention.

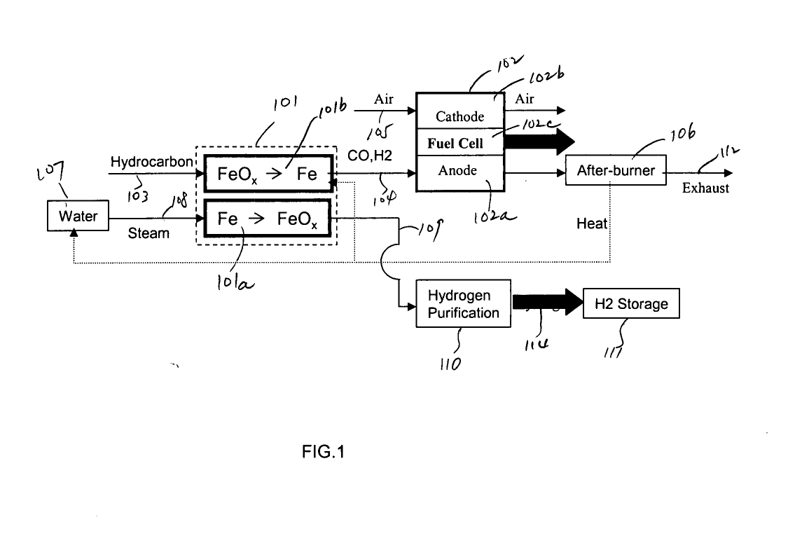

In FIGS. 1-4, to avoid repetition and to facilitate the detailed description, like reference numerals denote like elements.

### DETAILED DESCRIPTION OF THE PREFERRED EMBODIMENTS

In this detailed description, “fuel cell” and “fuel cell unit” also refer to one or more fuel cell stacks. A fuel cell is often formed by multiple identical fuel cell stacks. One kind of such fuel cell, known as “solid oxide fuel cell” (SOFC), is a ceramic fuel cell having an oxygen conducting electrolyte. SOFCs, which typically operate at temperatures between 400 to 1000° C., are made in tubular, planar or monolithic forms. These fuel cells use a hydrocarbon fuel, which may be any carbonaceous fuels, including natural gas, propane, methane, all paraffins, methanol, ethanol, propanol, gasoline, and diesel.

Because iron can have many oxidation states, there are many different iron oxide compounds, ranging from oxidation state 0 (i.e., elemental iron) to 3 (i.e., ferric oxide or Fe₂O₃), and many intermediate oxides FeOₓ, where x<1, FeO and Fe₃O₄. The present invention uses these oxidation states of iron to store oxygen. To simplify this detailed description, unless specified expressly, the term “iron oxide” or “FeO” represents any iron oxide with an oxidation state greater than 1, and “Fe” or “elemental iron” is used to represent any iron compound with an oxidation state lower or equal to 1.

FIG. 1 shows schematically the process reactant flows in fuel processor 101 and solid oxide fuel cell (SOFC) 102, in accordance with one embodiment of the present invention. Fuel processor 101 may include two or more beds of similar physical dimensions and characteristics. As shown in FIG. 1, bed 101a contains essentially elemental iron or iron oxide with low oxidation states. Bed 101b contains essentially iron oxides at higher oxidation states. A hydrocarbon fuel 103 (e.g., methane), after being desulfurized, is supplied to iron oxide bed 101b, which is controlled to a predetermined temperature, so that hydrocarbon fuel 103 (in the case of methane) reduces the iron oxides in iron oxide bed 101b to elemental iron, according to the reaction:
CH₄+FeO→CO+2H₂+Fe [3]
Iron oxide bed 101b is therefore also referred to as the reduction bed. Thus, the iron oxide in iron oxide bed 101b plays the role of an oxygen source for the reformation or partial oxidation of hydrocarbon 103. This approach avoids the conventional fuel dilution problems (i.e., fuel dilution by nitrogen in conventional partial oxidation and fuel dilution by steam in steam reforming and autothermal reforming processes). As indicated by reaction [3], elemental iron remains in bed 101b, while carbon monoxide and hydrogen (indicated by reference numeral 104 in FIG. 1) result as a mixture called “syngas”. Syngas 104 is directed to anode 102a of a high temperature electrochemical generator, represented by SOFC 102. (The high temperature electrochemical generator may also be, for example, a molten carbonate fuel cell.) Air¹ (indicated by reference numeral 105) is supplied to cathode 102b of fuel cell 102. When fuel cell 102 conducts an electrical current, the oxygen in air 105 is electrochemically reduced to oxygen ions, according to the reaction:
O₂→O²⁻+2e⁻ [4]
where the symbol “e⁻” denotes an electron. The oxygen ions diffuse across electrolyte membrane 102c to anode 102a to react with syngas 104 to form carbon dioxide and water, according to the reactions:
H₂+O²⁻→H₂O+2e⁻ [5]
CO+O²⁻→CO₂+2e⁻ [6]

¹ Throughout this detailed description, the term “air” is used to refer not just atmospheric air, but also to any oxygen bearing gas.

In this process, up to 85-90% of syngas 104 is consumed in the fuel cell to generate electricity. It is difficult to attain a higher efficiency without damaging the fuel cell. The remaining fuel is typically combusted in a so-called “after-burner” 106 to generate heat to supply water boiler 107, which converts water from an external source to steam (indicated by reference numeral 108). Steam 108 is then provided to elemental iron bed 101a. Elemental iron bed 101a may have been used previously as a reduction bed, so that it contains reduced elemental iron metal or iron at low oxidation states. In this instance, elemental bed 101a is an oxidation bed, as elemental iron is oxidized by the steam to form iron oxides of higher oxidation states and hydrogen, according to the reaction:
Fe+H₂O→FeO+H₂ [7]

Hydrogen stream 109 from oxidation bed 101a is purified in hydrogen purification step 110. Hydrogen purification step 110 includes a humidity removal step in which the hydrogen gas is cooled to a low temperatures to condense the steam in the hydrogen stream into water for removal. The purified hydrogen may be stored in hydrogen storage device 111. The condensed water may be re-circulated back to a water reservoir (not shown in FIG. 1).

Control mechanisms (e.g., valves) may be provided to alternately switch hydrocarbon fuel supply 103 from one bed to the other, and to correspondingly alternately switch steam supply 108 to the opposite bed. In this manner, continuous fuel conditioning for fuel cell 102 and continuous hydrogen generation for storage in hydrogen storage device 111 are simultaneously achieved. The switching of fuel and steam between beds may occur when the reduction bed is substantially reduced to elemental iron, and the oxidation iron bed is substantially oxidized to iron oxides. Oxidation bed 101a, therefore, acts as an oxygen storage device during oxidation with steam, and reduction or reformation bed 101b releases the stored oxygen to the reformation reaction with the hydrocarbon fuel. Neither the iron nor the iron oxide in beds 102a and 102b is therefore consumed in the reactions, the iron and iron oxides merely alternately change oxidation states, absorbing and releasing oxygen.

The basic steam-iron process described above for hydrogen production relies on variations in equilibrium ratios among iron species, steam and hydrogen, and as a function of temperature and species concentration. Also, the minimum reactor temperature needed for the reaction between hydrocarbon fuel and the iron oxides in the reduction bed is also influenced by the nature of the hydrocarbon fuel. Preferably, the operating temperature is between 500 to 1100° C. , depending on which hydrocarbon fuel is used. This high temperature operation is compatible with the high temperature operation (i.e., between 400 to 1000° C.) of the SOFC. Generally, the less stable the hydrocarbon (e.g., the longer chain hydrocarbons), the lower is the required operating temperature. For example, in methane, the preferred operating temperature for the reduction of iron oxides is at least 700° C. However, even at 700° C., not all the methane can be conditioned by iron oxides. The thermodynamic equilibrium indicates that as much as 30% of the methane remains un-converted. Unless the SOFCs consuming the fuel are direct hydrocarbon fuel cells (i.e., tolerant of large quantities of unconditioned hydrocarbons, such as those described in U.S. Pat. No. 6,214,485 and US Patent Application 20010029231), the un-converted methane may cause carbon deposition or coking at fuel cell anode 103a according to the reaction:
CH₄→C+2H₂ [8]

Carbon deposition can severely degrade fuel cell performance, and may even result in mechanical failures. In practice, most direct hydrocarbon fuel cells have a low power output, operate only at a temperature below 700° C., and do not need fuel conditioning. The present invention provides fuel cells a prior conditioning of hydrocarbon fuels. In such a fuel cell, the unconverted hydrocarbon is kept to a minimum to avoid carbon deposition in the fuel cell and the operating temperature is kept high to favor a complete conversion of the hydrocarbon by iron oxides. A complete reduction of iron is desirable as more hydrogen is produced during the subsequent oxidation with steam.

However, as the higher the temperature the reactor operates, the more likely the hydrocarbon fuel may spontaneously pyrolyse to form carbon according to reaction [7]. If carbon is deposited in the iron bed during reduction, carbon monoxide may form during the iron oxidation phase with steam, according to the reaction:
C+H₂O→CO+H₂ [9]

Carbon monoxide formation is undesirable, as carbon monoxide in oxidation bed 101a may poison PEMFCs. To minimize the deleterious effects of carbon monoxide, carbon monoxide treatment and hydrogen separation may be needed.

In one embodiment of the invention, carbon monoxide formed is removed by a further processing step. Hydrogen stream 109 (FIG. 1) from iron oxidation bed 101a is purified by water-shift reactors, where the carbon monoxide is removed according to reaction [2]. In additional, hydrogen stream 109 may be further purified using various hydrogen purification techniques, including hydrogen permeable membranes or pressure swing adsorption. In this embodiment, the reduction of iron oxides by hydrocarbon fuels can be done at an elevated temperature to ensure complete conversion of the hydrocarbon fuel to carbon monoxide and hydrogen. For example, for a methane fuel, a temperature of 800° C. or higher is appropriate.

Thermodynamically, carbon and iron oxides do not co-exist in equilibrium. Rather, at a high temperature (e.g., 700° C. or higher), carbon formed in reaction [7] during the reduction phase of iron oxide by the hydrocarbon fuel is promptly gasified by the iron oxides in the bed, according to the reaction:
C+FeO→CO+Fe [10]

Therefore, having some iron oxides left in the bed (i.e., maintaining incomplete reduction in the reduction bed, with iron oxides in some lower oxidation states) is nevertheless advantageous, as the iron oxides keep carbon deposition low. In practice, maintaining uniform incomplete reduction throughout the reactor is difficult in a conventional fixed bed reactor where the iron/iron oxide reactants are stationary and where the fuel supply enters the reactor at one end and leaves at the other end of the reactor. Generally, at the fuel inlet end of reduction bed 101b, the iron/iron oxide reactants are more reduced than the reactants at the fuel outlet end. Thus, carbon deposition is more likely at the fuel inlet end, even though the iron/iron oxide reactants at the fuel outlet end may not yet have been reduced. According to one embodiment of the present invention, to achieve a homogenous distribution of iron and iron oxide in reduction bed 101b, a continuous homogenizing action can be used to keep the iron/iron oxide reactants from a complete reduction to elemental iron. The homogenizing action may be achieved using either a conventional fluidized bed (i.e., by blowing the hydrocarbon gas upwards to catalyst particles to create a turbulent agitation), or mechanical agitation to mix the iron/iron oxide reactants.

Oxidation bed 101a may be operated at a slightly lower temperature than reduction bed 101b. The reaction in oxidation bed 101b between steam and iron/iron oxide favors the formation of steam at a high temperature (greater than 700° C.); at a lower temperature (e.g., lower than 700° C.), the equilibrium is significantly shifted in favor of forming iron oxides and hydrogen. At a much lower temperature, however, the reaction kinetics may be too slow. Therefore, oxidation bed 101a preferably operates at a temperature between 500 to 900° C., and more preferably between 600 to 750° C.

Hydrogen may be stored at high pressure. According to “Le Chatelier” principle, the reaction [7] is insensitive to pressure, so that the hydrogen may be produced under a high pressure from pressurized steam. With this arrangement, i.e., with the hydrogen being produced under a high pressure, a mechanical compressor to compress the hydrogen for storage may not be necessary.

According to reaction [3] above, in reduction bed 101b, each mole of methane (CH₄) produces one mole of elemental iron, one mole of syngas, which is one mole of carbon monoxide (CO) and two moles of hydrogen. The electrochemical conversion in the SOFC for each mole of syngas generates 383.3 kJ of electricity, assuming 50% electrical conversion efficiency, and 383.3 kJ of heat, including the heat generated by after-burner 106. The heat generated supplies the endothermic reduction of iron oxides (reaction [3]; ΔH=+236 kJ/mol CH₄) and brings one mole of water to boiling (ΔH=44 kJ/mol). The remaining heat warms up the gases. In iron oxidation bed 101a, steam oxidizes each mole of iron to one mole of iron oxide and one mole of hydrogen (i.e., reaction [7]).

Consequently, for each mole of methane fuel, the system generates 383.3 kJ of electricity and one mole of hydrogen, or 242 kJ, resulting in a system efficiency of 78%, which is much higher than the typical efficiency of 50% for fuel cells that generate only electricity.

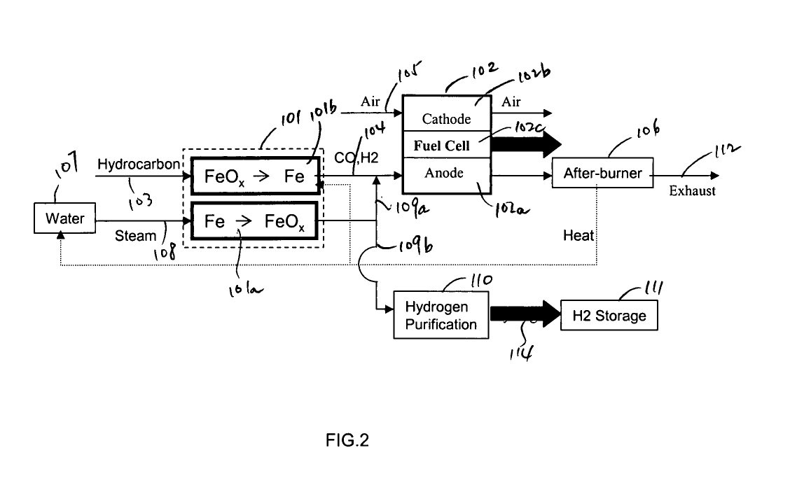

Many possible variations and modifications within the scope of the present invention are possible. For example, the ratio of electricity and hydrogen generated may be adjusted to demand. (The discussion above corresponds to the case of maximum hydrogen production.) When the electricity demand is high and the hydrogen demand is low, the hydrogen produced from oxidation bed 101a may be used in the solid oxide fuel cell 102 to further generate electricity. FIG. 2 shows schematically hydrogen stream 109a (i.e., a portion of hydrogen stream 109) produced from oxidation bed 101a is mixed with conditioned hydrocarbon fuel 104 from reduction bed 101a and directed to the high temperature electrochemical generator (i.e., fuel cell 102) for electricity generation, in accordance with one embodiment of the present invention. Furthermore, as carbon monoxide impurity in the hydrogen gas is not a concern, the SOFC output gas or “exhaust” (indicated by reference numeral 112), which contains large quantities of steam and carbon dioxide (CO₂), may be used as an oxidizing agent. That is, a portion of exhaust gas 112 is recycled back to oxidation bed 101a to generate hydrogen according to reactions [7] and [11]:
CO₂+Fe→CO+FeO [11]

In this manner, the need for an external source of steam (e.g., water boiler 107) for oxidation bed 101a is reduced or eliminated. The carbon monoxide and hydrogen generated in oxidation bed 101a can then be mixed with conditioned fuel flow 104 from reduction bed 101a, and the mixture is provided to SOFC anode chamber 102a.

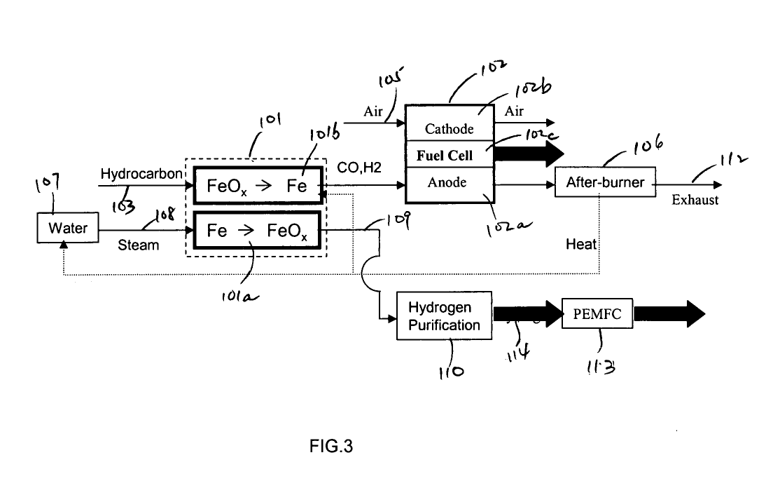

Another variation within the scope of the present invention is illustrated in FIG. 3. FIG. 3 illustrates schematically hydrogen stream 109 produced from oxidation bed 101a is purified and provided to proton exchange membrane fuel cell (PEMFC) 113 for further electricity generation. In this embodiment, steam from an external source (i.e., water boiler 107) oxidizes iron in oxidation bed 101a to generate hydrogen stream 109. Optionally, hydrogen stream 109 may be purified by a methanation process or in a preferential oxidation reactor to remove residual traces of carbon monoxide. The purified hydrogen stream 114 is then used in a low temperature fuel cell (e.g., a proton exchange membrane fuel cell) as fuel for further electricity generation. This arrangement has an additional advantage in some applications because that an PEMFC stack is typically less expensive than a SOFC stack. By dividing the hydrogen fuel between a smaller SOFC stack and a PEMFC stack, the total system may require a lesser capital investment than one generating electricity only from a large SOFC stack.

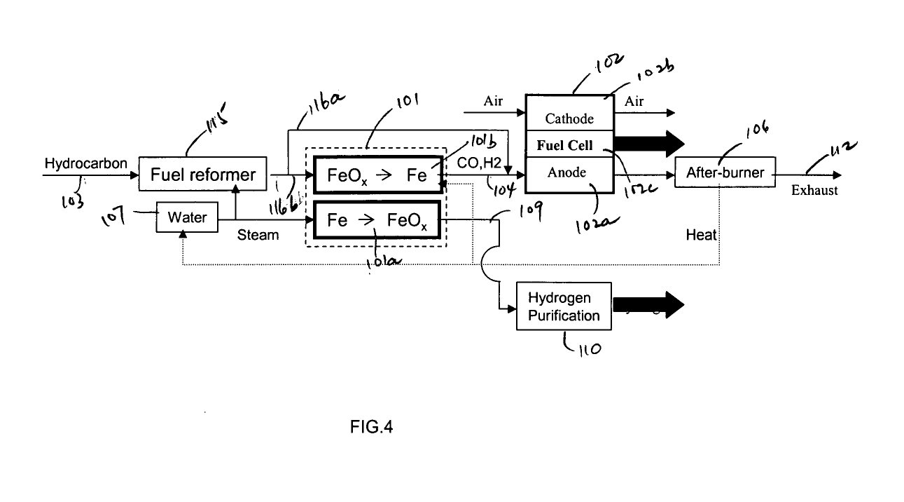

Yet another variation within the scope of the present invention is shown in FIG. 4. FIG. 4 illustrates schematically hydrocarbon fuel pre-reformed in reformer 115; a portion of the reformed fuel 116a is directed to reduction bed 101b, while the remaining (i.e., fuel flow 116b) is directed to a high temperature electrochemical generator (e.g., SOFC 102), in accordance with one embodiment of the present invention. Fuel reformer 115 converts hydrocarbon fuel 103 into syngas (i.e. a mixture of carbon monoxide and hydrogen), a portion of which (shown in FIG. 4 as reformed fuel flow 116a) supplies reduction bed 101b to regenerate elemental iron. The remaining portion 116b of the syngas is mixed with the product gases 104 from reduction bed 101b. This mixture is then used in high temperature electrochemical generator (e.g., SOFC 102) as fuel for electricity generation. The ratio of reformed fuel flows 116a and 116b may be dynamically adjusted according to relative amounts of electricity and hydrogen products needed. Hydrogen may be produced in the manner described with respect to FIG. 1, for example. The process of FIG. 4 avoids carbon deposition, as reduction bed 101b is not exposed to hydrocarbon fuel 103 directly, but to syngas only.

The above detailed description is provided to illustrate the specific embodiments of the invention and is not intended to be limiting. As mentioned above, numerous variations and modifications within the scope of the present invention are possible and will be apparent to those skilled in the art upon consideration of this detailed description. The present invention is set forth in the following claims.

1. A method for converting hydrocarbon fuels to electricity and hydrogen, the method comprising:
providing a hydrocarbon gas;
reacting the hydrocarbon gas in a reduction reaction of iron oxide in a first bed to produce a conditioned fuel gas containing hydrogen and carbon monoxide;
providing the conditioned fuel to an anode of a high temperature electrochemical generator having a cathode chamber receiving oxygen, the electrochemical generator reacting the conditioned fuel with the oxygen to generate electricity in an electrochemical process;
providing steam;
reacting the steam in an oxidation reaction of iron in a second bed to generate iron oxide and hydrogen; and
interchanging the first bed with the second bed.

2. The method of claim 1, wherein the reduction reaction is allowed to be carried out over a time period sufficient to reduce most but not all the iron oxide to elemental iron.

3. The method of claim 1, wherein the high temperature electrochemical generator comprises a molten carbonate fuel cell.

4. The method of claim 1, wherein the high temperature electrochemical cell comprises a solid oxide fuel cell.

5. The method of claim 1, wherein the hydrocarbon fuels include a gas selected from the group consisting of natural gas, propane, butane, parrafins, liquefied petroleum gas, gasoline, diesel, methanol, ethanol and propanol.

6. The method of claim 1, wherein the reduction reaction is carried out a temperature between 500 to 1100° C.

7. The method of claim 1, wherein the oxidation reaction is carried out at a temperature between 500 to 900° C.

8. The method of claim 1, wherein the oxidation reaction is carried out at a temperature between 600 to 750° C.

9. The method of claim 1, further comprising generating heat in an after-burner by combusting residual conditioned hydrocarbon fuel from the high temperature electrochemical generator.

10. The method of claim 9, wherein the heat generated in the after-burner is supplied to promote the oxidation reaction of iron.

11. The method of claim 1, wherein trace quantities of carbon monoxide in the hydrogen from the oxidation reaction of iron is removed using a process selected from the group consisting of methanation, preferential oxidation, or hydrogen gas separation.

12. The method of claim 1, wherein the hydrogen generated from the oxidation reaction of iron is stored and subsequently dispensed to vehicles.

13. The method of claim 1, wherein the oxidation reaction of iron is carried out under a pressure above atmospheric pressure.

14. The method of claim 1, wherein the first and second beds each further includes, as an oxygen source, any of ceria, zirconia, titania, alumina.

15. The method of claim 1, wherein the reactants in the second bed is agitated mechanically.

16. The method of claim 1, wherein the first bed operates as a fluidized bed.

17. The method of claim 1, wherein a portion of the hydrogen produced in the oxidation reaction is provided to the anode chamber of the high temperature electrochemical cell for electricity generation.

18. The method of claim 1, wherein a portion of the hydrogen generated in the oxidation reaction of iron is provided to a low temperature fuel cell for electricity generation.

19. The method of claim 1, wherein the low temperature fuel cell comprises a phosphoric acid fuel cell.

20. The method of claim 1, wherein the low temperature fuel cell comprises a proton exchange membrane fuel cell.

21. The method of claim 1, wherein a portion of an output gas from the high temperature electrochemical cell is re-circulated to the second bed.

22. The method of claim 1 being used at an energy station to provide electricity and hydrogen.

23. A method of claim 1 wherein, prior to the reduction reaction of iron oxide, the hydrocarbon gas is processed in a reforming processing that produces syngas from the hydrocarbon gas.

24. A method as in claim 23, wherein a portion of the syngas is provided to the anode chamber of the high temperature electrochemical generator as fuel for electricity generation.

25. A system for converting hydrocarbon fuels to electricity and hydrogen, the system comprising:
a hydrocarbon gas source;
a first bed for carrying out a reduction reaction of iron oxide using hydrocarbon gas from the hydrocarbon gas source, to provide a conditioned fuel gas containing hydrogen and carbon monoxide;
a high temperature electrochemical generator having an anode and a cathode, the high temperature electrochemical generator receiving the conditioned fuel at the anode and receiving oxygen at the cathode and generating electricity in an electrochemical process by reacting the conditioned fuel with the oxygen;
a steam source; and
a second bed for carrying out an oxidation reaction of iron with steam from the steam source to generate iron oxide and hydrogen.

26. The system of claim 25, wherein the first bed is exchanged with the second bed from time to time.

27. The system of claim 25, wherein the reduction reaction is allowed to be carried out over a time period sufficient to reduce most but not all the iron oxide to elemental iron.

28. The system of claim 25, wherein the high temperature electrochemical generator comprises a molten carbonate fuel cell.

29. The system of claim 25, wherein the high temperature electrochemical cell comprises a solid oxide fuel cell.

30. The system of claim 25, wherein the hydrocarbon fuels include a gas selected from the group consisting of natural gas, propane, butane, parrafins, liquefied petroleum gas, gasoline, diesel, methanol, ethanol and propanol.

31. The system of claim 25, wherein the reduction reaction is carried out a temperature between 500 to 1100° C.

32. The system of claim 25, wherein the oxidation reaction is carried out at a temperature between 500 to 900° C.

33. The system of claim 25, wherein the oxidation reaction is carried out at a temperature between 600 to 750° C.

34. The system of claim 25, further comprising an after-burner combusting residual conditioned hydrocarbon fuel from the high temperature electrochemical generator to generate heat.

35. The system of claim 34, wherein the heat generated in the after-burner is supplied to promote the oxidation reaction of iron.

36. The system of claim 25, wherein trace quantities of carbon monoxide in the hydrogen from the oxidation reaction of iron is removed using a process selected from the group consisting of methanation, preferential oxidation, or hydrogen gas separation.

37. The system of claim 25, wherein the hydrogen generated from the oxidation reaction of iron is stored and subsequently dispensed to vehicles.

38. The system of claim 25, wherein the oxidation reaction of iron is carried out under a pressure above atmospheric pressure.

39. The system of claim 25, wherein the first and second beds each further includes, as an oxygen source, any of ceria, zirconia, titania, alumina.

40. The system of claim 25, wherein the reactants in the second bed is agitated mechanically.

41. The system of claim 25, wherein the first bed operates as a fluidized bed.

42. The system of claim 25, wherein a portion of the hydrogen produced in the oxidation reaction is provided to the anode chamber of the high temperature electrochemical cell for electricity generation.

43. The system of claim 25, wherein a portion of the hydrogen generated in the oxidation reaction of iron is provided to a low temperature fuel cell for electricity generation.

44. The system of claim 25, wherein the low temperature fuel cell comprises a phosphoric acid fuel cell.

45. The system of claim 25, wherein the low temperature fuel cell comprises a proton exchange membrane fuel cell.

46. The system of claim 25, wherein a portion of an output gas from the high temperature electrochemical cell is re-circulated to the second bed.

47. The system of claim 1 being used at an energy station to provide electricity and hydrogen.

48. A system of claim 25 further comprising a fuel reformer which processes the hydrocarbon gas to produce syngas for use in the reduction reaction of iron oxide.

49. A system as in claim 48, wherein a portion of the syngas is provided to the anode chamber of the high temperature electrochemical generator as fuel for electricity generation.
